(19) United States
(12) Patent Application Publication
(10) Pub. No.: US 2006/0275554 A1
(43) Pub. Date: Dec. 7, 2006

(54) High performance kinetic spray nozzle

(76) Inventors: Zhibo Zhao, Novi, MI (US); Bryan A. Gillispie, Macomb Township, MI (US); Taeyoung Han, Bloomfield Hills, MI (US); Alaa A. Elmoursi, Troy, MI (US); Nilesh B. Patel, Macomb Township, MI (US)

Correspondence Address: DELPHI TECHNOLOGIES, INC., M/C 480-410-202, PO BOX 5052, TROY, MI, 48007, US

(21) Appl. No.: 11/500,104

(22) Filed: Aug. 7, 2006

Related U.S. Application Data
(63) Continuation-in-part of application No. 10/924,270, filed on Aug. 23, 2004.

(51) Int. Cl. C21D 1/00; B05D 1/08; C21D 1/62; B05C 5/00

(52) U.S. Cl. 427/446; 266/114; 118/300

(57) ABSTRACT

A nozzle assembly for a kinetic spray system includes a convergent portion, a throat portion, and a divergent portion, each cooperating together to define a passage therethrough for passing a mixture of powder particles suspended in a flow of a high pressure heated gas. The nozzle assembly further includes an extension portion attached to the divergent portion and extending to a distal end a pre-determined length from the divergent portion of the nozzle assembly. The extension portion permits a dragging force exerted on the powder particles by the flow of high pressure heated gas to act upon the powder particles for a longer duration of time, thereby permitting the powder particles to accelerate to a greater velocity than has been previously achievable.

This application is a continuation-in-part of U.S. Ser. No. 10/924270 filed Aug. 23, 2004

### BACKGROUND OF THE INVENTION

1. Field of the Invention

The subject invention generally relates to a nozzle assembly for a kinetic spray system.

2. Description of the Related Art

A nozzle assembly for a kinetic spray system typically comprises a mixing chamber for mixing a stream of powder particles under positive pressure with a flow of a heated gas. The mixing chamber is connected to a converging diverging deLaval type supersonic nozzle. The heated gas is also introduced into the mixing chamber under a positive pressure, which is set lower than the positive pressure of the stream of powder particles. In the mixing chamber, the flow of heated gas and the stream of powder particles mix together to form a gas/powder mixture. The gas powder mixture flows from the mixing chamber into the supersonic nozzle, where the powder particles are accelerated to a velocity between the range of 200 to 1,300 meters per second.

U.S. patent application Ser. No. 2005/0214474 A1 (the '474 application) discloses a deLaval type nozzle assembly for a kinetic spray system. The nozzle assembly includes a convergent portion defining an inlet and an outlet. The outlet is in spaced relationship relative to the inlet. A divergent portion defines an entrance and an exit, with the exit in spaced relationship relative to the entrance. A throat portion interconnects the outlet of the convergent portion and the entrance of the divergent portion. The convergent portion, the throat portion, and the divergent portion define a passage therethrough having a perimeter narrowing between the inlet and the outlet of the convergent portion, and expanding between the entrance and the exit of the divergent portion.

During operation of the nozzle assembly, such as the nozzle assembly disclosed in the '474 application, the particles exit the nozzle and adhere to a substrate placed opposite the nozzle assembly, provided that a critical velocity has been exceeded. The critical velocity of the powder particles is dependent upon its material composition and its size. Higher density particles generally need a higher velocity to adhere to the substrate. Additionally, it is more difficult to accelerate larger powder particles. Accordingly, the coating density and deposition efficiency of the particles can be very low with harder to spray powder particles. The velocity of the powder particles, upon exiting the nozzle assembly, varies inversely to the size and the density of the powder particles. Increasing the velocity of the flow of heated gas increases the velocity of the powder particles upon exiting the nozzle assembly. However, there is a limit to the achievable velocity of the flow of heated gas within the kinetic spray system. Thus, there is a need to improve the nozzle assembly to increase the velocity of the powder particles to improve adherence to the substrate of hard to spray powder particles having a high density and a larger size.

### SUMMARY OF THE INVENTION AND ADVANTAGES

The subject invention provides a nozzle assembly for a kinetic spray system. The nozzle assembly comprises a convergent portion defining an inlet and an outlet. The outlet is in spaced relationship relative to the inlet. A divergent portion defines an entrance and an exit, with the exit in spaced relationship relative to the entrance. A throat portion interconnects the outlet of the convergent portion and the entrance of the divergent portion. The convergent portion, the throat portion, and the divergent portion define a passage therethrough. The passage includes a perimeter narrowing between the inlet and the outlet of the convergent portion, and expanding between the entrance and the exit of the divergent portion. An extension portion further defines the passage and extends from the exit of the divergent portion to a distal end spaced a pre-determined length from the exit. The perimeter of the passage defined by the extension portion is at least equal to or greater than the perimeter of the passage defined by the exit of the divergent portion.

The subject invention also provides a method of coating a substrate with a powder applied by the kinetic spray system. The method comprises the steps of mixing the powder with a flow of heated gas; directing the flow of heated gas through the convergent portion, the throat portion, and the divergent portion of the nozzle assembly to accelerate the flow of heated gas and provide a drag force to act upon the powder to accelerate the powder; and passing the accelerated flow of heated gas and the powder through the extension portion of the nozzle assembly to provide additional time for the drag force of the flow of heated gas to act upon the powder to further accelerate the powder to a critical velocity.

Accordingly, the subject invention increases the overall length of the nozzle assembly while limiting an expansion ratio of the passage over the pre-determined length of the extension portion to avoid any negative effects that occur by merely extending the divergent portion. This increases the amount of time a stream of powder particles is exposed to a dragging force created by a flow of a heated gas through the nozzle assembly. This increased exposure of the stream of powder particles to the dragging force provides more time for the dragging force to accelerate the powder particles to an increased velocity not previously achievable. The increased velocity of the powder particles improves the ability of the kinetic spray system to adhere hard to spray materials such as high density and larger sized powder particles.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic layout illustrating a kinetic spray system;

FIG. 2 is a cross sectional view of a nozzle for use in the kinetic spray system;

FIG. 3 is an enlarged cross sectional view of an extension portion of the nozzle;

FIG. 4 is an end view of the extension portion of the nozzle shown in FIG. 3;

FIG. 5 is an enlarged cross sectional view of an alternative embodiment of the extension portion of the nozzle;

FIG. 6 is an end view of the alternative embodiment of the extension portion of the nozzle shown in FIG. 5;

FIG. 7 is a cross sectional view of an alternative embodiment of a conditioning chamber for the nozzle;

FIG. 8 is a cross sectional view of an alternative embodiment of the nozzle showing an alternative method of injecting a powder into a high pressure gas flowing through the nozzle; and

FIG. 9 is an end view an alternative embodiment of the extension portion of the nozzle showing a circular cross section.

### DETAILED DESCRIPTION OF THE INVENTION

The present invention comprises an improvement to the kinetic spray system and nozzle assembly 20 as generally described in U.S. patent application Ser. No. 2005/0214474 A1; U.S. Pat. Nos. 6,139,913 and 6,283,386; and the article by Van Steenkiste, et al. entitled “Kinetic Spray Coatings” published in Surface and Coatings Technology Volume III, Pages 62-72, Jan. 10, 1999. The disclosures of which are all herein incorporated by reference.

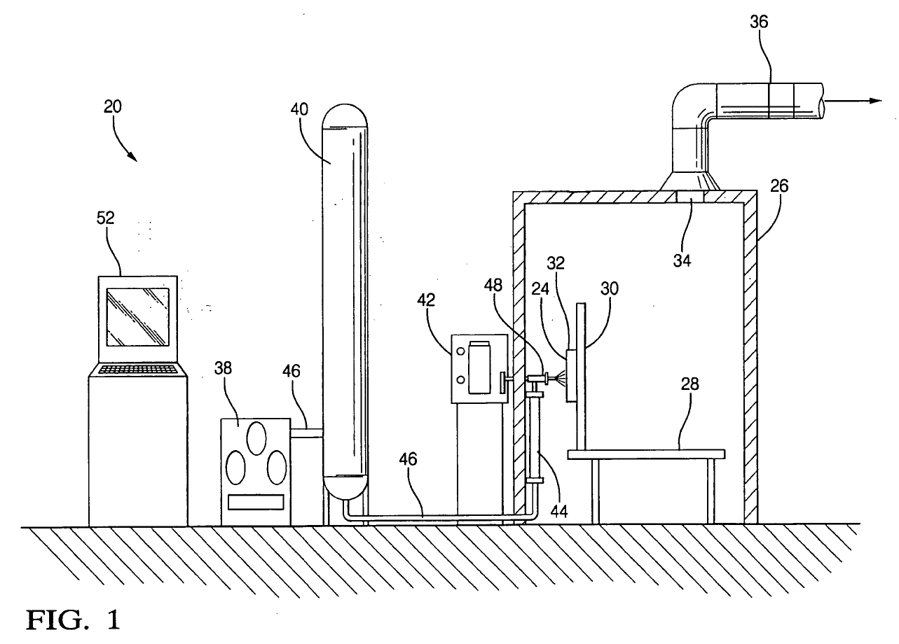

Referring to the Figures, wherein like numerals indicate corresponding parts throughout the several views, a kinetic spray system is generally shown at 20. Referring to FIG. 1, the kinetic spray system 20 applies a coating of powder particles 22 to a substrate material 24. A flow of heated gas suspends the powder particles 22, which are then sprayed onto the substrate 24 at high velocities. As disclosed in U.S. Pat. No. 6,139,913 the substrate material 24 may be comprised of any of a wide variety of materials including a metal, an alloy, a plastic, a polymer, a ceramic, a wood, a semiconductor, or any combination and mixture of these materials. The powder particles 22 used in the kinetic spray system 20 may comprise any of the materials disclosed in U.S. Pat. Nos. 6,139,913 and 6,283,386 in addition to other known powder particles 22. These powder particles 22 generally comprise a metal, an alloy, a ceramic, a polymer, a diamond, a metal coated ceramic, a semiconductor, or any combination and mixture of these materials. Preferably, the particles have an average nominal diameter between the ranges of 1 micron to 250 microns.

The kinetic spray system 20 includes an enclosure 26 in which a support table 28 or other support device is located. A mounting panel 30 is fixed to the support table 28, and supports a work holder 32. The work holder 32 is capable of movement in three dimensions and is able to support a suitable work piece. The work piece is formed from the substrate material 24 that is to be coated. The enclosure 26 includes surrounding walls defining at least one air inlet (not shown) and at least one air outlet 34 connected by a suitable exhaust conduit 36 to a dust collector (not shown). During operation of the kinetic spray system 20 the dust collector continually draws air from within the enclosure 26, and collects any dust or particles contained in the air for subsequent disposal before exhausting the air.

The kinetic spray system 20 further includes a gas compressor 38 capable of supplying a flow of a gas at a pressure up to 3.4 MPa (500 psi) to a ballast tank 40. Many different gases may be utilized in the kinetic spray system 20 including air, helium, argon, nitrogen, or some other noble gas. The ballast tank 40 is in fluid communication with a powder feeder 42 and a gas heater 44 through a system 20 of lines 46. The gas heater 44 supplies a flow of heated gas, the heated main gas described below, to a nozzle assembly 48. The powder feeder 42 mixes the powder particles 22 to be sprayed into a stream of unheated gas and supplies the mixture of unheated gas and powder particles 22 to a supplemental inlet line 50 to supply the nozzle assembly 48 with the powder particles 22. A computer 52 controls the pressure of the gas supplied to the gas heater 44 and to the powder feeder 42, and the temperature of the heated main gas exiting the gas heater 44.

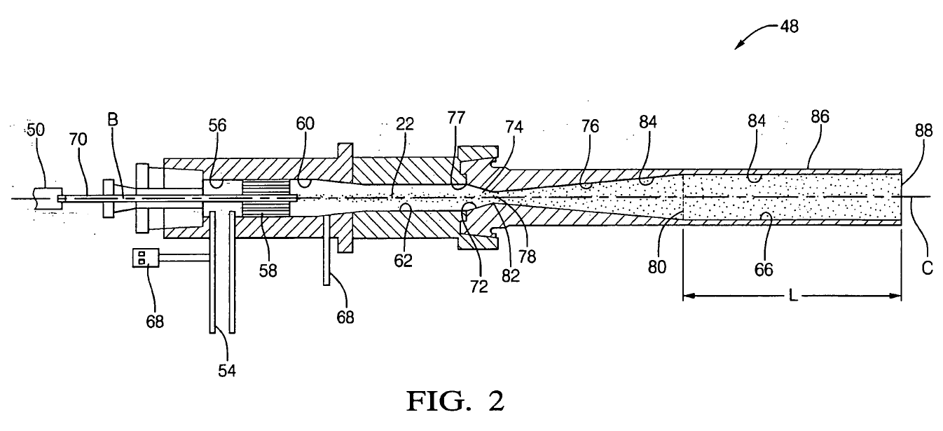

Referring to FIG. 2, a main gas passage 54 connects the gas heater 44 to the nozzle assembly 48. A premix chamber 56 is connected to the main gas passage 54 and directs the heated main gas through a flow straightener 58 and into a mixing chamber 60. The mixing chamber 60 mixes the powder particles 22 into the flow of heated main gas to suspend the powder particles 22 in the heated main gas. Preferably, the mixing chamber 60 is disposed upstream of a conditioning chamber 62 (described below). A temperature of the heated main gas is monitored by a temperature thermocouple 64 in the main gas passage 54, and a pressure sensor 68 connected to the mixing chamber 60 monitors a pressure of the heated main gas.

A powder injector tube 70 is in fluid communication with the supplemental inlet line 50 and directs the mixture of the gas and the powder particles 22 to the mixing chamber 60 to supply the mixing chamber 60 with the powder particles 22. The powder injection tube extends through the premix chamber 56 and the flow straightener 58 into the mixing chamber 60. Preferably, the injector tube has an inner diameter between the ranges of 0.3 millimeters to 3.0 millimeters, and is aligned collinear with a central axis C of the nozzle assembly 48.

The conditioning chamber 62 is positioned between the powder-gas mixing chamber 60 and a convergent portion 72 (described below) of the nozzle assembly 48. The conditioning chamber 62 increases the temperature of the powder particles 22 prior to mixing the powder particles 22 with the heated main gas flowing through the nozzle assembly 48. Preferably, as shown in FIG. 2, the conditioning chamber 62 is disposed upstream of the convergent portion 72. The conditioning chamber 62 includes a length along a longitudinal axis B, preferably collinear with the central axis C of the nozzle assembly 48. The interior of the conditioning chamber 62 has a cylindrical shape having an interior diameter equal to the inlet 77 of the convergent portion 72 of the nozzle assembly 48. The conditioning chamber 62 releasably engages the convergent portion 72 of the nozzle assembly 48 and the powder-gas mixing chamber 60. Preferably, the releasable engagement is by correspondingly engaging threads (not shown) between the exchange chamber, the convergent portion 72, and the conditioning chamber 62 respectively. It should be understood, however, that the releasable engagement may be through other devices such as a snap fit connection, a bayonet-type connection, or some other suitable type of connection. The length along the longitudinal axis B is preferably at least 20 millimeters or longer. The optimal length of the conditioning chamber 62 depends on the particles that are being sprayed and the substrate material 24. The optimal length can be determined experimentally, but is preferably between the ranges of 20 millimeters to 1000 millimeters.

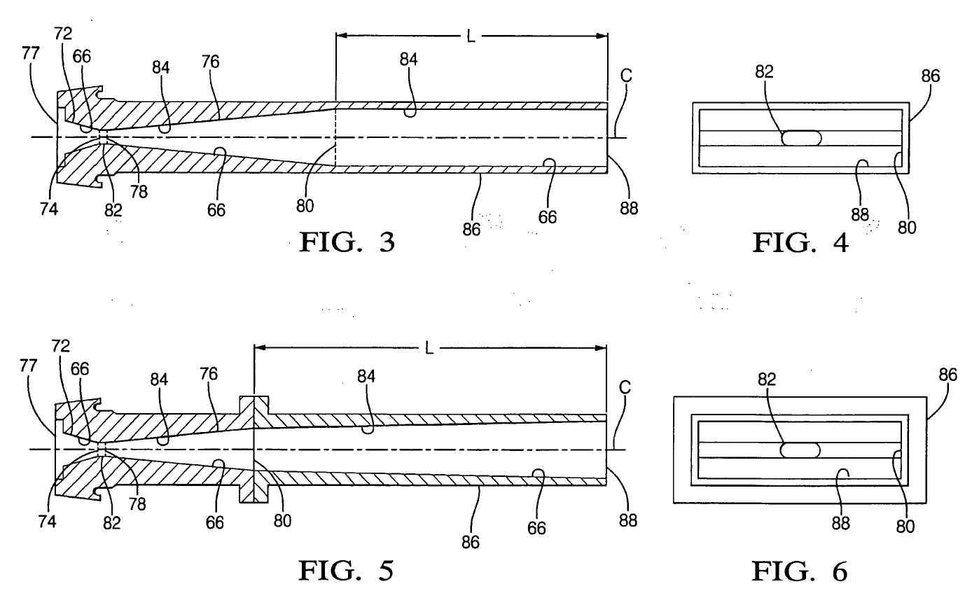

As best shown in FIG. 3, the nozzle assembly 48 includes the convergent portion 72, which defines an inlet 77 and an outlet 74. The outlet 74 is in spaced relationship relative to the inlet 77. A divergent portion 76 defines an entrance 78 and an exit 80, with the exit 80 being in spaced relationship relative to the entrance 78. A throat portion 82 interconnects the outlet 74 of the convergent portion 72 and the entrance 78 of the divergent portion 76. The convergent portion 72, the throat portion 82, and the divergent portion 76 form a de Laval type converging diverging nozzle as is known in the art, and cooperate together to define a passage 66 therethrough. The passage 66 includes a perimeter 84, which narrows between the inlet 77 and the outlet 74 of the convergent portion 72 and expands between the entrance 78 and the exit 80 of the divergent portion 76. An extension portion 86 further defines the passage 66 and extends from the exit 80 of the divergent portion 76 to a distal end 88 spaced a pre-determined length L from the exit 80. The pre-determined length L of the extension portion 86 is between the ranges of 20 millimeters and 1,000 millimeters. Accordingly, the nozzle assembly 48 includes an overall length spanning the convergent portion 72, the throat portion 82, the divergent portion 76, and the extension portion 86 between the ranges of 100 millimeters and 1,500 millimeters.

Based on aerodynamics, a drag force is applied to the powder particles 22 by the flow of heated main gas. The drag force may be expressed by the equation:

$$D = \frac{1}{2} \cdot {C}_{p} \cdot {ρ}_{g} \cdot {( {V}_{g} - {V}_{p} )}^{2} \cdot {A}_{p} . \qquad 1$$

Wherein Cₚ is a drag coefficient, ρ_{g} is a density of the heated main gas, V_{g} is a velocity of the heated main gas, Vₚ is a velocity of the powder particles 22, and Aₚ is an average cross sectional area of the powder particles 22. The drag force accelerates the powder particles 22 to a critical velocity. It has been discovered that there is a wasted potential in the drag force because the powder particles 22 are not exposed to the drag force for a long enough period of time, i.e., the powder particles 22 may achieve a higher velocity if the powder particles 22 are exposed to the drag force for a longer period of time. Accordingly, by adding the extension portion 86 onto the divergent portion 76 of the nozzle assembly 48, the powder particles 22 are exposed to the drag force for a longer period of time, thereby minimizing the wasted potential, and thereby maximizing the drag force applied to the powder particles 22.

The heated main gas flows through the convergent portion 72, throat portion 82, and then into the divergent portion 76, where the heated main gas accelerates to high velocities. As the velocity of the heated main gas increases, the density of the heated main gas decreases. This is evident with reference to the conservation of mass within the nozzle assembly 48 expressed by the equation:
f=A·V_{g}·ρ_{g} 2.

Wherein f is a mass flow rate of the heated main gas, A is a cross sectional area of the perimeter 84 of the nozzle assembly 48 at any given location within the passage 66, V_{g} is the velocity of the heated main gas, and ρ_{g} is the density of the heated main gas. The decrease in the density of the heated main gas negatively affects the drag force. Additionally, an expansion ratio defined as a rate of change of the perimeter 84 of the passage 66 over a distance along the central axis C extending through the passage 66 limits the increase in the velocity achievable in the divergent portion 76. As the heated main gas flows through the divergent portion 76, a boundary layer near an outer wall of the nozzle assembly 48 develops, and tends to separate, creating a shock wave in the flow of heated main gas. The shock wave significantly decreases the velocity of the heated main gas. Accordingly, it is not effective to merely extend the divergent portion 76 of the nozzle assembly 48 outward. Therefore, the perimeter 84 of the passage 66 defined by the extension portion 86 is at least equal to or greater than the perimeter 84 of the passage 66 defined by the exit 80 of the divergent portion 76. It should be understood that the perimeter 84 of the passage 66 defines a cross sectional shape. Referring to FIGS. 3 and 4, the cross sectional shape defined by the perimeter 84 may be uniform throughout the pre-determined length L of the extension portion 86. It should be understood that the uniform cross sectional shape of the extension portion 86 includes an expansion ratio equal to zero or negligibly small. Alternatively, referring to FIGS. 5 and 6, the cross sectional shape of the perimeter 84 defined by the extension portion 86 may slightly increase in area relative to the exit 80 of the divergent portion 76 as the extension portion 86 extends from the exit 80 of the divergent portion 76 to the distal end 88 of the extension portion 86. Nevertheless, the slightly increasing cross sectional shape defined by the extension portion 86 includes a significantly smaller expansion ratio relative to the expansion ratio of the divergent portion 76. The uniform cross sectional shape and the alternative slightly increasing cross sectional shape defined by the perimeter 84 of the extension portion 86 permit the drag force to act on the powder particles 22 for a longer period of time without significantly decreasing the density of the heated gas, and also without creating the shock wave within the flow of heated gas.

As described above, the expansion ratio of the passage 66 defined by the divergent portion 76 is greater than the expansion ratio of the passage 66 defined by the extension portion 86. This permits the heated main gas to flow through the extension portion 86 without continuing to decrease the density of the heated main gas and to avoid shock waves in the heated main gas. While it is contemplated that the divergent portion 76 may include a constant expansion ratio as shown in FIGS. 3 and 5, the expansion ratio of the divergent portion 76 preferably continuously decreases from the entrance 78 to the exit 80 of the divergent portion 76 as shown in FIG. 7. This may further be described as having a parabolic or curved shape that continuously diverges from the central axis C at a continuously decreasing rate as the distance from the entrance 78 of the divergent portion 76 increases in a direction toward the exit 80 of the divergent portion 76. The parabolic or curved shaped divergent portion 76 provides the greatest possible expansion ratio immediately downstream of the throat portion 82, thereby rapidly increasing the velocity of the heated main gas near the throat portion 82 than near the extension portion 86 to maximize the velocity difference between the heated main gas and the powder particles 22 and to increase the drag force applied on the powder particles 22. Accordingly, the divergent portion 76 has the largest expansion ratio nearest the throat portion 82, and the smallest expansion ratio at the exit 80 of the divergent portion 76. As a result, the gas pressure at the divergent portion 76 drops rapidly due to a high expansion ratio. This allows the powder particles 22 to be injected by a low pressure powder feeder 42 through the powder injector tube 70 as shown in FIG. 7.

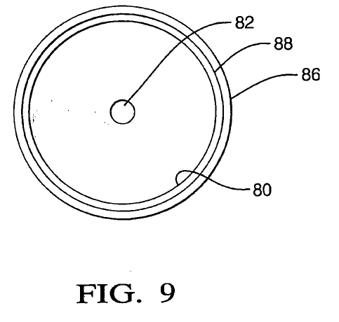

The cross section of the perimeter 84 defined by the divergent portion 76 and the extension portion 86 may include a variety of shapes, but preferably includes a rectangular shape. The rectangular shaped cross section of the perimeter 84 defined by the extension portion 86 at the distal end 88 includes a long dimension between the range of 6.0 millimeters and 24.0 millimeters and a short dimension between the range of 1.0 millimeters and 6.0 millimeters. Alternatively, as shown in FIG. 9, the perimeter 84 of the passage 66 defined by the divergent portion 76 and the extension portion 86 may define a cross section having a circular shape.

Preferably, as indicated in FIG. 5, the extension portion 86 is releasably attached to the divergent portion 76. The releasable attachment may be by correspondingly engaging threads between the divergent portion 76 and the extension portion 86, a snap fit connection, a bayonet type connection, or some other suitable connection. However, as shown in FIG. 3, it is contemplated that the extension portion 86 may be integrally formed with the divergent portion 76 as a single unit.

The perimeter 84 of the passage 66 defined by the throat portion 82 defines a cross section. As shown in FIG. 9, the cross section may include a circular shape. The circular shaped cross section of the throat may include a diameter between the ranges of 1.0 millimeters and 5.0 millimeters. However, it should be understood that the cross section of the throat portion 82 may include other shapes. Preferably, referring to FIGS. 4 and 6, the cross section of the throat portion 82 includes an elliptical shape. Excessive wear in the rectangular shaped cross section of the divergent portion 76 adjacent the throat portion 82 has been noticed. The excessive wear negatively affects the performance of the nozzle assembly 48. The excessive wear has been attributed to rapid radial expansion of the heated main gas and powder particles 22 exiting the circular shaped cross section of the throat portion 82. This excessive wear is reduced by elongating the cross section of the throat portion 82. Accordingly, the elliptically shaped cross section of the throat portion 82 helps minimize the excessive wear noticed in the rectangular shaped cross section of the divergent portion 76.

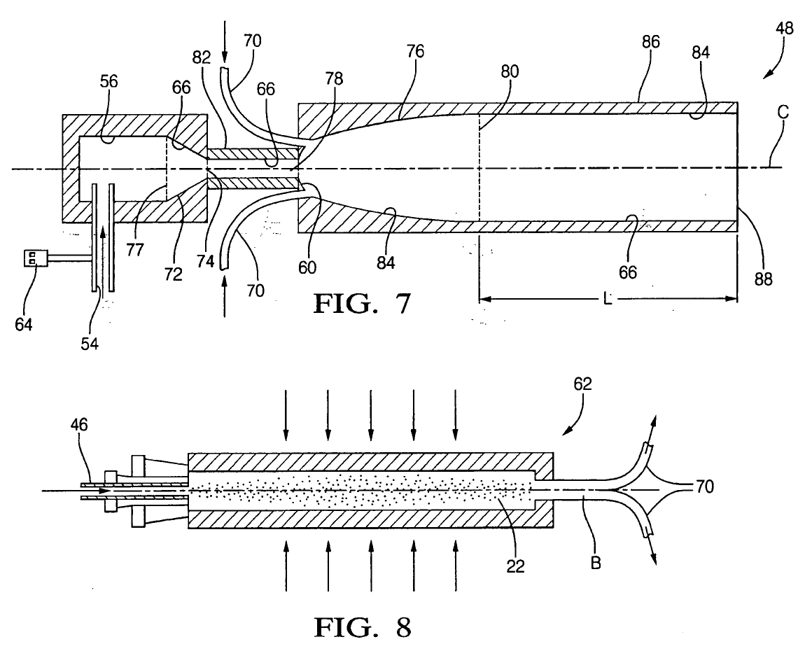

Referring to FIGS. 7 and 8, an alternative embodiment of the nozzle assembly 48 is shown. In the alternative embodiment, the particle injector tube interconnects the conditioning chamber 62 and the divergent portion 76 of the nozzle assembly 48 to supply the powder particles 22 to the divergent portion 76 of the nozzle assembly 48. The mixing chamber 60 is disposed within the divergent portion 76, adjacent the throat portion 82, for mixing the powder particles 22 with the flow of heated main gas in the divergent portion 76 of the nozzle assembly 48 as the heated main gas enters the divergent portion 76 from the throat portion 82. In the alternative embodiment, the longitudinal axis B of the conditioning chamber 62 is not collinear with the central axis C, and in fact, the conditioning chamber 62 is separated form the nozzle assembly 48. The particle injector tube interconnects in fluid communication the conditioning chamber 62 and the mixing chamber 60 within the divergent portion 76. Powder buildup and clogging of the throat portion 82 is thereby minimized by providing the powder particles 22 directly into the divergent portion 76 of the nozzle assembly 48 instead of directing the powder particles 22 through the throat portion 82. In the alternative embodiment, the gas pressure in the divergent portion 76 drops rapidly due to the high expansion ratio. This enables the powder particles 22 to be injected at a lower pressure (less than 100 psi), compared to the preferred embodiment shown in FIG. 2, which injects the powder particles 22 at a higher pressure (typically greater than 300 psi). Furthermore, a detached conditioning chamber 62 may be included that uses external heating to heat the powder particles 22 to an elevated temperature (up to 80% of the melting temperature of the powder particles 22). The detached conditioning chamber 62 is in fluid communication with the divergent portion 76 through the powder injector tube 70, as shown in FIG. 7. Alternatively, the detached conditioning chamber 62 may also be in fluid communication with the premix chamber 56 through the powder injector tube 70, as shown in FIG. 2.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A nozzle assembly for a kinetic spray system, said assembly comprising:
a convergent portion defining an inlet and an outlet in spaced relationship relative to said inlet;
a divergent portion defining an entrance and an exit in spaced relationship relative to said entrance;
a throat portion interconnecting said outlet of said convergent portion and said entrance of said divergent portion;
said convergent portion, said throat portion, and said divergent portion defining a passage therethrough having a perimeter narrowing between said inlet and said outlet of said convergent portion and expanding between said entrance and said exit of said divergent portion; and
an extension portion further defining said passage and extending from said exit of said divergent portion to a distal end spaced a pre-determined length from said exit with said perimeter of said passage defined by said extension portion at least equal to or greater than said perimeter of said passage defined by said exit of said divergent portion.

2. An assembly as set forth in claim 1 further comprising a central axis extending through said passage and wherein said passage includes an expansion ratio defined as a rate of change of said perimeter of said passage over a distance along said central axis with said expansion ratio of said passage defined by said divergent portion greater than said expansion ratio of said passage defined by said extension portion.

3. An assembly as set forth in claim 2 wherein said expansion ratio of said divergent portion continuously decreases from said entrance to said exit of said divergent portion.

4. An assembly as set forth in claim 2 wherein said pre-determined length of said extension portion is between the range of twenty (20) millimeters and one thousand (1,000) millimeters.

5. An assembly as set forth in claim 4 wherein said perimeter of said passage defined by said divergent portion and said extension portion defines a cross section having a rectangular shape.

6. An assembly as set forth in claim 5 wherein said rectangular shaped cross section of said perimeter defined by said extension portion at said distal end includes a long dimension between the range of six (6) millimeters and twenty four (24) millimeters and a short dimension between the range of one (1) millimeter and six (6) millimeters.

7. An assembly as set forth in claim 4 wherein said perimeter of said passage defined by said divergent portion and said extension portion defines a cross section having a circular shape.

8. An assembly as set forth in claim 1 wherein said extension portion is releasably attached to said divergent portion.

9. An assembly as set forth in claim 1 wherein said extension portion is integrally formed with said divergent portion.

10. An assembly as set forth in claim 1 wherein said perimeter of said passage defined by said throat portion defines a cross section having an elliptical shape.

11. An assembly as set forth in claim 1 wherein said nozzle includes an overall length spanning said convergent portion, said throat portion, said divergent portion, and said extension portion between the range of eighty (80) millimeters and fifteen hundred (1,500) millimeters.

12. An assembly as set forth in claim 1 further comprising a conditioning chamber for increasing the temperature of a powder prior flowing the powder through said convergent portion, said throat, and into said divergent portion with said conditioning chamber disposed upstream of said convergent portion.

13. An assembly as set forth in claim 12 further comprising a mixing chamber disposed upstream of said conditioning chamber for mixing a flow of a heated gas with the powder.

14. An assembly as set forth in claim 13 further comprising at least one particle injector tube for supplying the powder to said mixing chamber.

15. An assembly as set forth in claim 14 wherein said at least one particle injector tube includes a longitudinal axis parallel to said central axis and in fluid communication with said mixing chamber.

16. An assembly as set forth in claim 1 further comprising a conditioning chamber for increasing the temperature of a powder prior to flowing the powder through said divergent portion.

17. An assembly as set forth in claim 16 further comprising a mixing chamber disposed within said divergent portion adjacent said throat portion for mixing a flow of a heated gas with the powder.

18. An assembly as set forth in claim 17 further including at least one particle injector tube interconnecting said conditioning chamber and said divergent portion for supplying the powder to said mixing chamber in said divergent portion to mix the powder with the flow of the heated gas as the heated gas enters said divergent portion from said throat portion.

19. A method of coating a substrate with a powder applied by a kinetic spray system including a nozzle assembly having a convergent portion, a throat portion, a divergent portion, and an extension portion, the nozzle assembly further including an expansion ratio defined as a rate of change of a perimeter of a passage defined by the nozzle assembly over a distance along a central axis of the nozzle assembly with the expansion ratio of the divergent portion greater than the expansion ratio of the extension portion, said method comprising the steps of:
mixing the powder with a flow of heated gas;
directing the flow of heated gas through the convergent portion, the throat portion, and the divergent portion of the nozzle assembly to accelerate the flow of heated gas and provide a drag force to act upon the powder to accelerate the powder;
passing the accelerated flow of heated gas and the powder through the extension portion of the nozzle assembly to provide additional time for the drag force of the flow of heated gas to act upon the powder to further accelerate the powder to a critical velocity.

20. A method as set forth in claim 17 wherein said nozzle assembly includes a conditioning chamber for heating the powder prior to directing the powder through the divergent portion of the nozzle assembly.

21. A method as set forth in claim 18 wherein the heated gas flows from the throat portion to the divergent portion and the expansion ratio of the passage defined by the divergent portion is greater adjacent the throat portion than adjacent the extension portion and the step of directing the flow of heated gas through the convergent portion, the throat portion, and the divergent portion is further defined as directing the flow of heated gas through the convergent portion, the throat portion, and the divergent portion to increase the velocity of the flow of heated gas at a faster rate near the throat portion than near the extension portion.

22. A method as set forth in claim 19 wherein said nozzle assembly further includes at least one injector tube interconnecting in fluid communication the conditioning chamber and the divergent portion of the nozzle assembly and the step of mixing the powder with a flow of heated gas is further defined as heating the powder with a flow of heated gas in the divergent portion adjacent the throat portion of the nozzle assembly.

23. A method as set forth in claim 17 wherein the perimeter of the passage defined by the throat portion includes an elongated shape and the step of directing the flow of heated gas through the convergent portion, the throat portion, and the divergent portion of the nozzle assembly is further defined as directing the flow of heated gas through the convergent portion, the elongated perimeter of the throat portion, and the divergent portion.

24. A method as set forth in claim 21 wherein the elongated shape of the perimeter of the passage defined by the throat portion is further defined as an elliptical shape.
